(19) United States
(12) Patent Application Publication
(10) Pub. No.: US 2003/0075184 A1
(43) Pub. Date: Apr. 24, 2003

(54) Disposable mouthguard

(76) Inventor: Stephen J. Persichetti, Portland, OR (US)

Correspondence Address: KOLISCH HARTWELL, P.C., 520 S.W. YAMHILL STREET, SUITE 200, PORTLAND, OR, 97204, US

(21) Appl. No.: 10/265,307

(22) Filed: Oct. 4, 2002

Related U.S. Application Data
(60) Provisional application No. 60/346,153, filed on Oct. 19, 2001.

(51) Int. Cl. A61C 5/14

(52) U.S. Cl. 128/861

(57) ABSTRACT

A user-formable, wax based mouthguard and methods for preparing and using the mouthguard.

### CROSS-REFERENCE TO RELATED APPLICATIONS

This application claims the priority under 35 U.S.C. §119 and applicable foreign and international law of U.S. Provisional Patent Application Serial No. 60/346,153 filed Oct. 19, 2001 which is hereby incorporated by reference in its entirety for all purposes.

### FIELD OF THE INVENTION

The invention relates to mouthguards, and more specifically to user-formable, disposable mouthguards.

### BACKGROUND

Sports activities are becoming increasingly popular in today's health-conscious society. As a result, greater numbers of children and adults are benefiting from participation in activities ranging from standard team sports, such as soccer and basketball, to extreme sports such as speed skiing and kitesurfing. All sports activities come with a risk of contact injury. A particularly vulnerable injury site is the athlete's mouth. Mouthguard use is an effective mechanism to reduce risk of injury. However, many people who could benefit from wearing a mouthguard, do not use one because an economical easy-to-use mouthguard option is not available.

Shock-absorbing mouthguards were introduced as protective devices, initially, to cushion blows to the jaw and mouth during high contact sports such as boxing and football. However, mouthguards have been found to be invaluable protection for contact and non-contact sports alike. Studies demonstrate that mouthguard use in many sports prevents dental injuries, such as loose, dislodged, or broken teeth; injuries to the tongue, lips, and surrounding facial regions; and may even lessen the incidence and severity of concussions. Furthermore, studies suggest that more widespread and consistent mouthguard use should be promoted further for all types of athletes.

Mouthguards function primarily by placing a shock-absorbing material between the upper and lower dental arches. The shock-absorbing material prevents direct contact between the upper and lower arches, thus cushioning forces exerted parallel to the teeth. In addition, the shock-absorbing material may cushion forces directed perpendicular to the teeth, for example, by extending over front and lateral portions of the upper or lower dental arch. In order to effectively reduce the effect of both types of forces, the mouthguard must be properly positioned within the mouth of the athlete at all times during athletic activity. Therefore, the mouthguard should be designed so that it is retained stably and comfortably in position, in association with one of the dental arches during athletic activity. In addition, to promote widespread use, the mouthguard should be inexpensive, lack any unpleasant taste, and be easily customized to an individual's particular dental configuration.

Mouthguards are currently of three general types: stock mouthguards, custom-made mouthguards, and mouth-formed or user-formed mouthguards. None of these currently available mouthguards meet all of the criteria cited above, as detailed below.

Stock mouthguards are generically dimensioned for use by many athletes and thus do not conform well to the dentition of an individual athlete. As a result, stock mouthguards are not retained in position effectively without clenching the jaws. Furthermore, stock mouthguards tend to be uncomfortable and bulky, and may affect speaking and breathing. Stock mouthguards generally tend to discourage people from using mouthguards.

Custom-made mouthguards represent the other end of the mouthguard spectrum. These high-end mouthguards are prepared for athletes by dental professionals based on the specific dentition and needs of each athlete. However, custom-made mouthguards are too expensive to be a practical option for most athletes.

Mouth-formed mouthguards are provided with a moldable portion. After suitable preparation of the mouthguard, the athlete bites down on the mouthguard to produce an impression of the athlete's dentition in the moldable portion. Mouth-formed mouthguards are unsatisfactory for at least several reasons. For example, “boil-and-bite” mouthguards, are prepared for use by placing the mouthguard in very hot water, to soften the mouthguard sufficiently to form the dental impression. In many cases, very hot water is not available to the athlete at the site of athletic activity, thus discouraging mouthguard use. Even when boiling water is available, the mouthguard may be too hot, and therefore cause burning in the user's mouth. If the user allows the mouthguard to cool so as to avoid burning, then the mouthguard may be too hard to form a good impression. In addition, mouth-formed mouthguards are made generally from plastic resins that may impart an unpleasant taste to the mouthguard. The plastic resins may also harden with prolonged exposure to saliva. In general, a fundamental problem common to all currently available mouthguards is that their high cost and/or lack of appealing characteristics tend to limit mouthguard use to the committed athlete, leaving many other active children and adults unprotected and vulnerable to dental injuries.

Based on the inadequacies of available mouthguards, a mouthguard is still required that will generally encourage more widespread use of mouthguards among the general population.

### SUMMARY OF THE INVENTION

The invention provides an inexpensive conformable mouthguard and methods for preparing and using the mouthguard. The mouthguard for protecting teeth includes an arch-shaped baseplate, and an impression layer supported by the baseplate. In a preferred embodiment of the invention, both the baseplate and the impression layer are comprised of wax. The impression layer is substantially more deformable than the baseplate after exposing the mouthguard to hot tap water. The mouthguard is preferably made substantially of biodegradable materials in a configuration that is suitable for single-use and disposal.

### BRIEF DESCRIPTION OF THE DRAWINGS

FIG. 1 is an isometric view of an embodiment of a mouthguard constructed according to aspects of the invention.

FIG. 2 is a rear elevation view of the mouthguard of FIG. 1.

FIG. 3 is a side elevation view of the mouthguard of FIG. 1.

FIG. 4 is a top plan view of the mouthguard of FIG. 1, illustrating an impression made by a dental arch.

FIGS. 5A-C are sectional side elevation views, viewed generally along line 5—5 of FIG. 4, showing dental arches of a person before, during, and after conforming the impression layer to a person's dentition.

### DETAILED DESCRIPTION

The invention provides a comfortable user-formable mouthguard that is easy to use and suitable for use in a disposable, single use product configuration. The mouthguard is preferably comprised of wax, which allows the mouthguard to conform and adhere effectively to the user's dentition. As a result, the mouthguard is stably retained on the dental arch, allowing speech and breathing while minimizing the likelihood of swallowing or aspirating the mouthguard. In addition, wax composition allows the mouthguard to be manufactured inexpensively, creating an affordable mouthguard option for a large number of potential users. Wax also is generally biodegradable. Thus, coupled with low cost, the mouthguard may be offered as an environmentally conscious, single-use alternative.

A “single-use” or “disposable” mouthguard is a mouthguard designed to be used typically for a single physical activity session and then thrown away. A single physical activity session may be a game or a fraction of a game such as a football or basketball game. A duration of a session may range from a few minutes to several hours or most of a day. A physical activity session could mean a school recess or a child's free play in a park or a playground.

A single use mouthguard may offer distinct advantages not found in other mouthguards. For example, a single-use mouthguard avoids problems with hygiene that are associated with repeated use of a mouthguard. In addition, a single-use mouthguard encourages a novice to experiment with mouthguard use. A single-use mouthguard may be flavored or similarly modified to increase its appeal, an option not effective for multiple-use mouthguards. A disposable mouthguard is also advantageous for children who tend to lose or misplace their belongings, and whose dental configuration is changing. As a result of these and other potential advantages, mouthguards produced according to the present invention may promote increased mouthguard use and reduce dental and facial sports injuries.

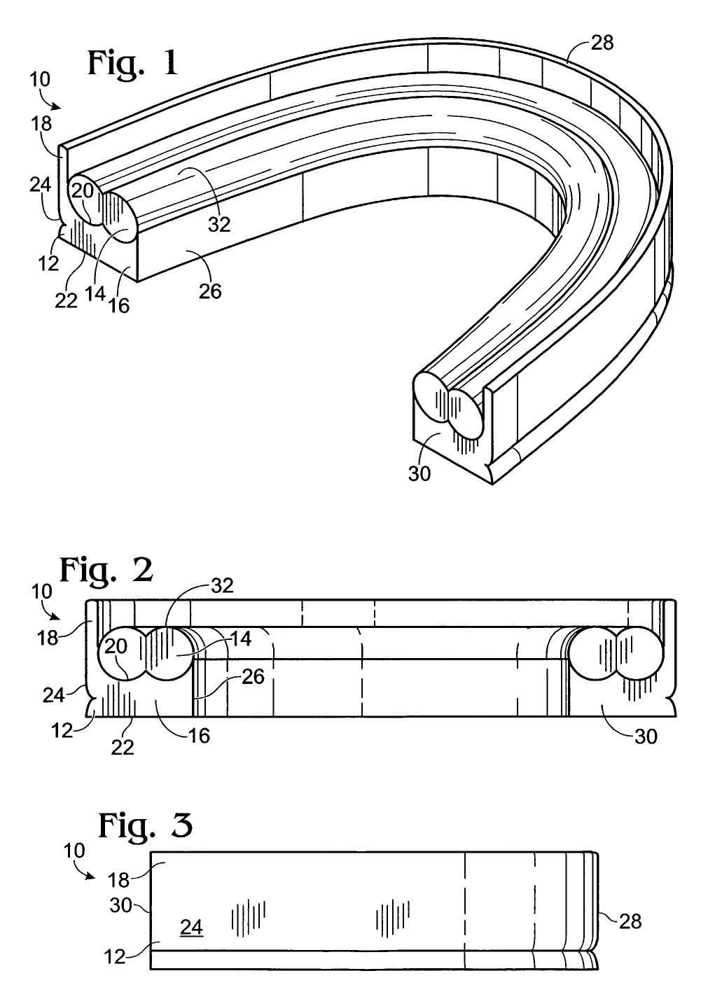

A mouthguard 10 produced according to aspects of the invention is shown in FIGS. 1-3. Mouthguard 10 is formed of at least two associated structures, a baseplate 12 and an impression layer 14. Baseplate 12 acts as a shock absorber that maintains separation between the upper and lower dental arches and cushions impacts on the mouth and jaw. Baseplate 12 is generally arch-shaped, with dimensions determined by a human dental arch. Typically, the contour of the human maxillary dental arch is the basis for the shape of baseplate 12. The hard and soft palates generally are not covered by baseplate 12, which may minimize stimulation of the gag reflex, keep the airway open to facilitate breathing, and make mouthguard 10 comfortable to wear. Baseplate 12 may be a single generic size suitable for a broad range of dental arch sizes, or may have a distinct target size for a narrow range of arch sizes.

Baseplate 12 may include a floor portion 16 and a wall portion 18. Floor portion 16 extends generally parallel to the plane of the baseplate arch and is structured to maintain spacing between the upper and lower arches of a user. This thickness should be sufficient to give baseplate mechanical stability, prevent contact between the upper and lower teeth during normal use, and dissipate and deflect traumatic forces. However, the thickness may not exceed the freeway space between the upper and lower teeth. If exceeded, the mouthguard may be uncomfortable to the user because floor portion 16 may push the mandible downward into an unnatural rest position. A suitable thickness for floor portion 16 may be about 0.5 mm to 10 mm, about 2 mm to 8 mm, or about 3 mm to 6 mm.

Floor portion 16 may include layer interface 20 and contact region 22. Interface 20 and region 22 generally face outward toward upper and lower dental arches, respectively, while the mouthguard is in use. However, their positions relative to the dental arches may be reversed in some uses of the mouthguard. Layer interface 20 generally supports impression layer 14 and may be joined to the impression layer, for example, by direct contact between floor portion 16 and layer interface 20. Contact region 22 typically contacts lower teeth of the user, along a portion of or the entire arch, when the user's jaw is clenched. Floor portion 16 also generally includes an outer region 24, an inner region 26, a front end portion 28, and a back end portion 30.

Baseplate 12 may include a wall portion 18 that extends away from floor portion 16 near outer region 24. Wall portion 18 may extend in a direction generally perpendicular to floor portion 16, as shown in FIGS. 1 and 2, or wall portion 18 may extend at other angles and have a linear, curved, or other nonlinear geometry in profile. Wall portion 18 may be disposed externally relative to the teeth of the mouthguard user, and thus may act as an external shield to protect the teeth from a front or side impact to the mouth region. Alternatively, or in addition, wall portion 18 may limit lateral movement of impression layer 14 and may guide positioning of the dental arch. Wall portion 18 may have a height that is approximately the same as the exposed height of an average tooth and therefore may cover the outward facing surfaces of a dental arch. Alternatively, wall portion may have any other suitable height. The thickness of wall portion 18 may be selected so that it is thin enough to prevent uncomfortable outward pressure on the user's lip when the mouthguard is in position, but thick enough to remain intact during normal use.

Impression layer 14 may be joined to baseplate 12. Impression layer 14 has multiple functions. The impression layer functions to allow the user to customize the fit of the mouthguard. The impression layer also acts adhesively to retain the mouthguard in contact in contact with the upper arch of the user. The impression layer also functions along with the baseplate to absorb shock from an impact event that occurs during an athletic activity. Joining may be directly to layer interface 20 of floor portion 16 or may be indirectly through intermediate structures, and/or layers. Joining should be sufficiently stable that baseplate 12 and impression layer 14 do not separate during normal mouthguard use. Impression layer 14 has a thickness sufficient to conform and adhere to a user's dentition and thus may be referred to as an adhesive layer. The contact surface between impression layer 14 and the user's dental arch should be sufficient to retain the mouthguard in stable contact with the dental arch during a physical activity session. Impression layer 14 may have a thickness sufficient to contact the crowns of a substantial fraction of the teeth in a dental arch. The thickness also may be sufficient to contact the side portions of the teeth, covering some or all of the side portions of a representative tooth in the arch (see FIG. 5). In some embodiments the thickness and/or width of the impression layer may vary based on differences in tooth size and structure within the dental arch. For example, the width or thickness of the impression layer that receives and conforms to the molars may be greater than for the incisors.

Impression layer 14 may have a generally arch-shaped structure that extends along floor portion 16 of baseplate 12. Impression layer 14 includes a receiving region 32 that receives teeth of the dental arch. Prior to deformation by the user, receiving region 32 may have a generally planar or grooved structure, as shown in FIGS. 1 and 2. Alternatively, receiving surface 32 may be preformed to include a channel that is generally complementary to a dental arch. The channel may serve to properly guide the user's teeth into impression layer 14.

Impression layer 14 is formed of an impression material that is able to conform and adhere to the teeth of the user's dental arch. The impression material should retain the mouthguard in stable association with the dental arch during a physical activity session and may have an adhesion quality that assists in the retention. In addition, the impression material may be softened with heating, particularly heating with hot tap water, but may be sufficiently rigid to hold its shape at human body temperature. Moreover, the impression material may be biodegradable and is inexpensive enough to promote single use.

A suitable impression material includes wax or a wax material. The impression material may be at least about 50% wax (w/w), at least about 90% wax (w/w), or may at least substantially include wax. Wax generally comprises any organic, heat-sensitive material formed substantially of hydrocarbons and/or esters of fatty acids that are insoluble in water but soluble in many organic solvents. A wax is distinct from a plastic resin, lacking the polymer structure typical of plastic resins. A wax that may be suitable for the impression layer is periphery wax, such as a blue, border-molding type obtainable from Heraeus Kulzer Dental Products, South Bend, Ind. This periphery wax has a melting temperature of 170.6° F. (77° C.) and an inherent tackiness. Periphery wax molds to allow a snug fit over the dental arch, providing a degree of retention that may not be found in other mouthguard materials. Furthermore, the pliable nature of periphery wax may provide a more comfortable fit than resilient materials that are used in boil-and-bite mouthguards.

Baseplate 12 may be formed from any material that is capable of supporting the impression layer, physically strong enough to withstand impacts produced during sports activities, yet soft enough to cushion these impacts. The baseplate material may be less sensitive to softening with heat than the impression material. However, a suitable baseplate material also may be soft enough to allow teeth to deform floor portion 16 somewhat, forming a weak impression in layer interface 20 and contact region 22. In addition, the baseplate material may have less adhesion quality than the impression material.

A suitable baseplate material may include wax or a wax material, and may be at least about 50% wax (w/w), at least about 90% wax (w/w), or may substantially include wax. In particular, a wax that may be suitable is baseplate wax, such as pink, ADA Type 1 wax, with a melting point of 161.6° F. (72° C.). Baseplate wax is a tough, yet pliable, all-purpose wax. This wax may be hard, but not brittle, generally has a long shelf life and may be consistent batch after batch. In addition, baseplate wax may be shaded to resemble gum tissue. Baseplate wax is obtainable from Heraeus Kulzer Dental Products, South Bend, Ind.

In some embodiments, both the baseplate and impression layer include wax. In these embodiments, the baseplate and impression layer may be bonded to one another by melting the baseplate and/or impression layer at the interface between these structures. Melting may be accomplished by molding each structure separately and fusing them afterward with surface heat. Alternatively, the structures may be joined by sequential molding, for example, a first structure (baseplate or impression layer) may be molded, allowed to solidify, and then the other structure molded using a portion of the first structure as part of the mold.

The baseplate and/or impression layer may include additives that generally are not wax. These additives may alter a property of the mouthguard or a portion thereof. The altered property may be detected by any of the senses, including smell, touch, sight, and/or taste, and/or may be a physical property. For example, an additive may add a flavoring material that provides a flavor property, such as the flavor of a fruit, other food, or an artificial flavor. Alternatively, or in addition, the additive may add a scent/odor to the mouthguard, such as the odor of a food or other pleasant or identifying association. Furthermore, the additive may add a color to the mouthguard, such as a pink color to simulate the appearance of the gums, or a white color to simulate the appearance of the teeth. In addition, the additive may add designs or other visually detectable features or structures, such as swirls, or sparkles. The additive also may alter the moldability, melting point, adhesiveness, texture, hardness, or any other physical parameter of the mouthguard.

The mouthguard may be prepared for use by heating. Heating may soften immersion layer 14 relative to baseplate 12. Heating may be carried out by exposing the mouthguard to hot tap water. Exposure may be for about ten seconds to two minutes, or about thirty seconds. The hot tap water may have a temperature of about 100° F. to about 130° F., or about 110° F. The mouthguard may also be prepared by heating in a microwave oven on high for approximately 30 seconds.

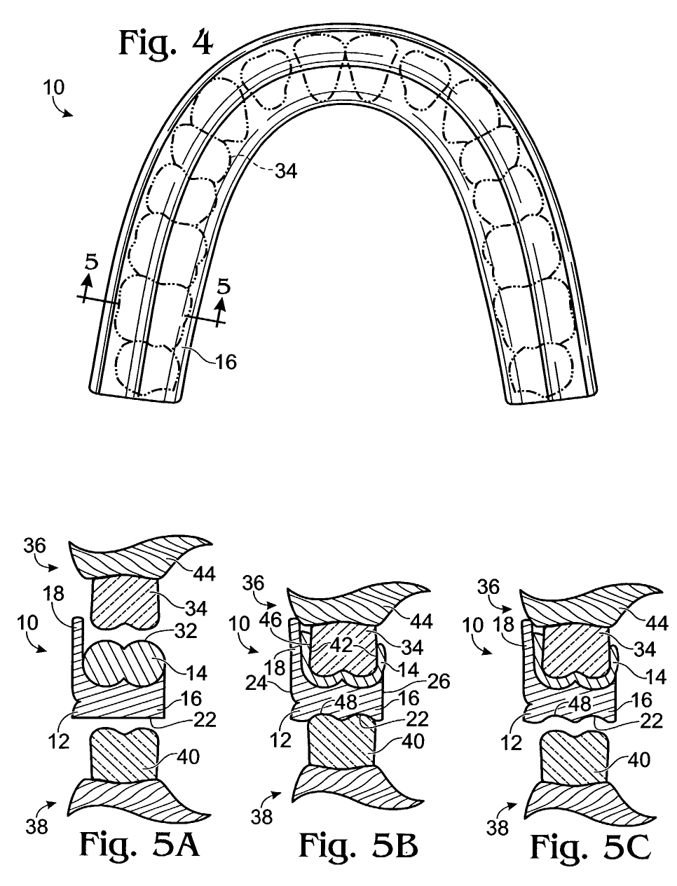

FIG. 4 illustrates how a user's dental arch may be positioned in impression layer 14. Teeth 34, shown in dotted outline, extend into impression layer 14, generally above floor portion 16 and inside wall portion 18.

FIGS. 5A-C illustrate a cross-section of a mouthguard before and after customizing the mouthguard to a person's teeth. In the following discussion dental arches of the user are referred to as retaining and positioning arches. Generally, the retaining arch is the user's upper arch, and the positioning arch is the user's lower arch. However, these arch assignments may be reversed based on user preference and/or in some embodiments.

The user positions the mouthguard, typically after softening, within the mouth between retaining and positioning dental arches 36, 38, respectively. As indicated in FIG. 5A, teeth 34 of the retaining arch and teeth 40 of the positioning arch are positioned in an opposed relationship to receiving region 32 of impression layer 14 and contact region 22 of floor portion 16.

In a preferred method of conforming a mouthguard to a person's teeth, after softening mouthguard 10 by exposing it to hot water, the user uses his or her fingers to press soft impression layer 14 against teeth 34 with sufficient pressure to significantly penetrate and conform impression layer 14 to the dental configuration of the upper arch as shown in FIG. 5C.

In an alternative method of customizing the mouthguard, the user bites the softened mouthguard as shown in FIG. 5B. As the user bites the mouthguard, shown in FIG. 5B, upper teeth 34 enter and deform impression layer 14 so that the layer conforms to the teeth. Here, teeth 34 are shown to be in a spaced relation with floor portion 16. However, teeth 34 of the retaining arch may deform impression layer sufficiently to contact floor portion 16 at contact sites and may form a weak impression in floor portion 16. As shown, impression layer 14 may be extruded lateral to the dental arch, conforming to side portion 42 of teeth 34. Thus, impression layer 14 may further cushion against impact. In this example, impression layer 14 does not extend to contact gum portion 44 of the user. In contrast, wall portion 18 may be positioned external to teeth 34 and may extend to approximately the tooth-gum border 46. As shown here, wall portion 18, impression layer 14, and floor portion 16 may be dimensioned to prevent the impression layer material from being extruded significantly over outer and inner regions 24, 26 of baseplate 12 during deformation by the dental arch.

Concomitant with deformation of impression layer 14, positioning arch 38 contacts contact region 22 of baseplate 12, shown in FIG. 5B. Positioning arch 38 may deform the baseplate to form weak impression 48. Thus contact region 22 may provide weak impression 48 that seats the positioning arch when the jaw closes.

Once the user has customized mouthguard 10 as described above, mouthguard 10 adheres to retaining arch 36, without continued clenching of the jaw, as shown in FIG. 5C. Retention is generally maintained during a physical activity session of about thirty minutes or longer. Thus, the user is able to breathe and speak normally without interference from the mouthguard and without dislodging the mouthguard. However, the mouthguard may be removed easily, typically with aid of the user's hands, at any desired time.

In some embodiments, mouthguard 10 may be provided as a set or package of plural disposable mouthguards. A person may use a new mouthguard from the package for each physical activity session, discarding the mouthguard at the completion of the session. The package may include instructions that suggest how mouthguards should be used. The instructions may instruct the person to discard each mouthguard after a single use or after a single athletic session.

While the invention has been disclosed in its preferred form, the specific embodiments thereof as disclosed and illustrated herein are not to be considered in a limiting sense as numerous variations are possible. Applicants regard the subject matter of the invention to include all novel and non-obvious combinations and subcombinations of the various elements, features, functions and/or properties disclosed herein. No single feature, function, element or property of the disclosed embodiments is essential to all embodiments of the invention. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of applicants' invention.

We claim:

1. A mouthguard for protecting teeth comprising
an arch-shaped baseplate, and
an impression layer supported by the baseplate, wherein both the baseplate and the impression layer are comprised of wax, the impression layer being substantially more deformable than the baseplate after exposing the mouthguard to hot tap water.

2. The mouthguard of claim 1, the baseplate being configured to prevent contact between a person's upper and lower teeth, and generally to absorb shock associated with impact to the person's mouth or jaw during an athletic activity.

3. The mouthguard of claim 1, wherein the impression layer is configured to mold and adhere to a person's upper dental arch.

4. The mouthguard of claim 1, wherein the baseplate has a floor portion and an external wall portion.

5. The mouthguard of claim 1, wherein the impression layer has an adhesion property that causes the mouthguard to stick continuously to a person's upper dental arch during an athletic activity, and to be easily removable at the end of the activity.

6. The mouthguard of claim 1, the impression layer being readily conformable to a person's dentition after exposing the impression layer to tap water at a temperature of approximately 110° F. for approximately 30 seconds.

7. The mouthguard of claim 1, wherein the impression layer is comprised of periphery wax.

8. The mouthguard of claim 1, wherein the baseplate and the impression layer are made substantially of biodegradable materials.

9. The mouthguard of claim 1, wherein at least one of the baseplate and the impression layer includes an additive that confers a property, the property being selected from the group consisting of flavor, taste, smell, texture, color, moldability, hardness, melting point, tackiness, and appearance.

10. A mouthguard for protecting teeth, comprising
a shock-absorbing baseplate having the shape of a human dental arch, and
an impression layer joined to the baseplate and comprised of wax material, the wax material being formulated to conform and adhere to a person's dentition.

11. The mouthguard of claim 10, wherein the impression layer is readily conformable to the person's dentition after exposing the impression layer to tap water at a temperature of approximately 110° F. for approximately 30 seconds.

12. The mouthguard of claim 10, wherein the mouthguard is adapted to be positioned and compressed between upper and lower dental arches of a person, so that the impression layer receives and retains one of the upper and lower dental arches.

13. The mouthguard of claim 10, wherein the baseplate has a floor portion and an external wall portion.

14. The mouthguard of claim 10, wherein the impression layer is formulated to allow substantial molding after heating under hot tap water, and to be substantially rigid enough to hold its shape at human body temperature.

15. The mouthguard of claim 10, wherein the impression layer is configured to mold and adhere to a person's upper dental arch.

16. The mouthguard of claim 10, wherein the baseplate is comprised of wax.

17. The mouthguard of claim 16, wherein the baseplate includes at least 50% (w/w) wax.

18. The mouthguard of claim 16, wherein the baseplate and the impression layer are each comprised of at least about 90% (w/w) wax.

19. The mouthguard of claim 10, wherein the baseplate and the impression layer are made substantially of biodegradable materials.

20. A mouthguard for protecting teeth, comprising
a baseplate having the shape of a human dental arch, and
an impression layer supported by the baseplate and comprising periphery wax, the impression layer being formulated to conform and adhere to a person's dentition.

21. The mouthguard of claim 20, wherein the baseplate is comprised of wax.

22. The mouthguard of claim 20, wherein the baseplate and the impression layer are each comprised of at least 50% (w/w) wax.

23. The mouthguard of claim 20, wherein the baseplate and the impression layer are each comprised of at least about 90% (w/w) wax.

24. A mouthguard for protecting teeth, comprising
an impact-absorbing arch-shaped guard member,
an impression layer joined to the guard member, the impression layer being formulated to conform and adhere to a person's dental arch.

25. A method of protecting teeth, comprising
selecting a first mouthguard from a package containing multiple mouthguards,
customizing the mouthguard to a person's dental arch so that the mouthguard adheres to the dental arch,
participating in a first physical activity session,
discarding the mouthguard upon completion of the first physical activity session,
selecting a second mouthguard from the package, and repeating the customizing, participating, and discarding steps with respect to a second physical activity session.

26. A kit for protecting teeth, comprising
a mouthguard, and
an instruction sheet including an instruction to discard the mouthguard upon completion of a single physical activity session.

27. A mouthguard for protecting teeth, comprising
an arch-shaped baseplate comprised of wax, and
an adhesive material distributed on the baseplate for adhering the baseplate to a person's upper arch during a physical activity session.

28. The mouthguard of claim 27, wherein the adhesive is comprised of wax.

29. The mouthguard of claim 27, wherein the adhesive is comprised of periphery wax.

30. The mouthguard of claim 28, wherein the adhesive material substantially conforms to a person's teeth by biting the mouthguard after exposing the mouthguard to hot tap water.
